(19) United States
(12) Patent Application Publication
(10) Pub. No.: US 2022/0408964 A1
(43) Pub. Date: Dec. 29, 2022

(54) AUTOMATIC COFFEE ROASTING, GRINDING AND BREWING

(71) Applicant: Steve CHA, Franklin Lakes, NJ (US)

(72) Inventor: Steve CHA, Franklin Lakes, NJ (US)

(21) Appl. No.: 17/847,452

(22) Filed: Jun. 23, 2022

Related U.S. Application Data
(60) Provisional application No. 63/213,823, filed on Jun. 23, 2021.

(51) Int. Cl. A47J 31/42

(52) U.S. Cl. CPC A47J 31/42

(57) ABSTRACT

A method and electronic device are disclosed herein for roasting, grinding and degassing coffee. The electronic device includes a roaster, a grinder, a degassing chamber and a processor. The processor implements the method, including: roast raw coffee beans, thereby resulting in roasted coffee beans, grind the roasted coffee beans using a grinder, thereby resulting in ground coffee, and initiating a degassing stage using the degassing chamber, thereby accelerating degassing of carbon dioxide from the ground coffee.

### CLAIM OF PRIORITY

This application claims, pursuant to 35 USC 119, priority to, and the benefit of the earlier filing date of, that provisional patent application entitled “Automatic Coffee Roasting, Grinding and Brewing” filed in the U.S. Patent Office on Jun. 23, 2021 and afforded Ser. No. 63/213,823, the contents of which are incorporated the reference herein.

### TECHNICAL FIELD

Various embodiments of the disclosure relate to an electronic device and a method for automatically brewing coffee, and more particularly, to automatically roasting, grinding and brewing coffee.

### BACKGROUND

Over 2 billion cups of coffee are consumed world-wide, every day. Coffee is a drink that is brewed from coffee beans, which are the seeds of the coffee tree. A coffee tree grows a fruit known as coffee cherries which contain coffee beans. Removing the pulp of the coffee cherries, drying, fermenting, and milling results in what is commonly referred to as the “green coffee bean.” The green coffee bean is dry, rough to the touch, and capable of being stored for later use.

Coffee beans are roasted in preparation for consumption. Once roasted, the coffee beans are typically left to “de-gas” for seven to ten days, releasing carbon dioxide and other gasses that build up during the roasting process, which normalizes the flavor of the resulting coffee. Otherwise, the resulting brewed coffee tastes bitter. After the beans are sufficiently degassed, the roast beans are ground, and then brewed into coffee. For optimal taste, the ground beans further must be consumed/brewed within a week or so before becoming stale. Variation in timing also occurs depending on a specific type of bean. Taken together, the end result of these factors is that many consumers of coffee today drink mainly stale coffee which lacks in freshness.

### SUMMARY

Many coffee consumers may wish to roast their own coffee beans. This allows them more specific control over their preferred flavors, roast darkness, coffee bean mixtures, etc. for a fresh cup of coffee. Home-roasting and grinding may be often more environmentally friendly, especially as compared to “K-cup” home brewing machines which involve using wasteful individually-packaged cups of ground coffee. Some present statistics suggest there would be as many 1 billion K-cup containers in circulation. Furthermore, freshly roasted coffee beans are often perceived as more flavorful and fresh than store-bought roast coffee beans, which may have been sitting unused for a long period of time, and certainly superior to stale pre-ground coffee.

However, home-roasting coffee beans presents challenges. Skins fall off the beans during the roasting process and must be removed. Furthermore, the process of roasting coffee beans often creates fumes and smells which can be perceived as harsh and unpleasant for home brewers. This problem is exacerbated by the need to degas the roasted beans for extended periods of time, during which the user is unable to brew coffee from the roasted beans, and must suffer exposure to continued release of fumes and smells from the roasted beans.

One aspect of invention is to provide a single coffee system where roasting, degassing, and brewing can be achieved such that a fresh coffee can be brewed for a better and fresh taste.

Another aspect of invention is to provide an economical coffee system by offering roasted beans at home, office or at your own venue by eliminating the need to purchase the roasted bean from a third party roaster.

Another aspect of invention is to provide a single coffee system which enable a user to selectively adjust the roasting time and/or degassing duration to accommodate each user's preference.

Another aspect of invention is to provide an automatic roasting system that is fast and easy in which the coffee beans are roasted to one's preference for fresh and flavorful coffee.

Another aspect of invention is to provide more coffee options where users can select and combine different whole bean types and apply different roasting styles to obtain unique blends for themselves.

Another aspect of invention is to provide an automatic coffee maker that allows to adjust time, temperature, and fan speed during roasting procedure, and to enable to selectively save and change the roasting preferences for subsequent roasting.

Another aspect of invention is to provide an automatic coffee maker that allows to consumers to naturally degass the roasted beans by providing a storage area for the roasted beans to be degassed for at least one or more days prior to brewing according to the user's preference.

Another aspect of invention is to provide an automatic coffee maker that allows to roast the raw beans and also independently or simultaneously brew the roasted beans for consumption.

A further aspect of invention is to provide more coffee options where users can select and combine different whole bean types and apply different roasting styles to obtain unique blends for themselves.

Yet, a further aspect of invention is to shorten the lengthy degassing process that last a few days into a few minutes such that all in one system can provide an automatic roasting, degassing and brewing that is easy and fast for fresh and flavorful coffee at home, office, or any venue.

According to certain embodiments of the disclosure, a coffee bean roaster and degasser are disclosed, including: a roaster configured to roast raw coffee beans, thereby resulting in roasted coffee beans, a grinder configured to grind the roasted coffee beans, thereby resulting in ground coffee, and a degassing stage configured to accelerate degassing of carbon dioxide from the ground coffee.

According to certain embodiments of the disclosure, a method for preparing coffee is disclosed, including: using a roaster, roasting raw coffee beans, thereby resulting in roasted coffee beans, grinding the roasted coffee beans, thereby resulting in ground coffee; and degassing carbon dioxide from the ground coffee.

According to certain embodiments of the disclosure, an electronic device for automatically roasting, grinding and oxidizing coffee, is disclosed, including: an external housing, a blower motor, a roasting housing defining a roasting chamber, including: an opening through which coffee beans are received into the roasting chamber, a base forming a bottom of the roasting chamber, a ceramic heating element, a coffee skin receptacle, connected to the roasting housing through a first shaft, a coffee bean grinder, connected to the roasting housing through a second shaft, and a oxidizing chamber, connected to the blower motor through a third shaft.

### BRIEF DESCRIPTION OF THE DRAWINGS

FIG. 1 is a perspective view of an exterior of an example automatic coffee bean roaster, grinder and brewer;

FIG. 2A is an interior view of components in the example automatic coffee bean roaster, grinder and brewer;

FIG. 2B is an interior view of components in a second example automatic coffee bean roaster, grinder and brewer;

FIG. 2C is a sectional view of a roaster chamber, skin receptacle and catalytic converter, as utilized within the example automatic coffee bean roaster, grinder and brewer;

FIG. 2D is an sectional view of a roaster chamber, skin receptacle and catalytic converter, as utilized within another example automatic coffee bean roaster, grinder and brewer;

FIG. 2E is a sectional view of a grinder, water tank, and combination degassing-oxidizing brewing chamber;

FIG. 2F illustrates internal components of the example automatic coffee bean roaster via control of a computer controller;

FIG. 3 is a flowchart illustrating an example method of roasting coffee beans in the example automatic coffee bean roaster, grinder and brewer; and

FIG. 4 is a flowchart illustrating an example method of grinding the roasted coffee beans and exposing the grounds to oxidation in the example automatic coffee bean roaster, grinder and brewer;

FIG. 5A illustrates an example roasting chamber according to certain embodiments of the invention;

FIG. 5B illustrates an example degassing chamber according to certain embodiments of the invention;

FIG. 5C illustrates a side view of another example roasting chamber according to certain embodiments of the invention;

FIG. 5D illustrates a side view of another example roasting chamber according to certain embodiments of the invention;

FIG. 6 is a perspective view of an exterior of another example automatic coffee bean roaster, grinder and brewer;

FIG. 7 is a perspective view of an example roasting chamber, skin (e.g., chaff) filter, and grinder;

FIG. 8 is a perspective view of a front face of the automatic coffee roaster, grinder and degasser, with a cutaway showing internal components including the fan and roasting chamber;

FIGS. 9A, 9B, 9C, and 9D illustrates some example user interface elements for a control panel of the automatic coffee roaster, grinder and degasser; and

FIG. 10 is a perspective view of a roasting chamber.

### DETAILED DESCRIPTION

An automatic coffee roaster, grinder and degasser is described in the present disclosure. The automatic roaster, grinder and degasser combines the functions of roasting and deskinning coffee, grinding them and degassing and/or oxidizing them through positive pressure in order to facilitate expedient brewing of coffee from raw (or “green”) coffee beans. Furthermore, to benefit the user experience, a catalytic converter is provided to reduce the harshness of fumes resulting from the roasting process. Accordingly, users will be able to brew freshly roasted and ground coffee on-site with increased convenience. This may produce further societal benefits in reducing reliance on pre-skinned coffee beans, K-cups and waste associated with packaging and transport. Consumers may benefit economically as raw green coffee beans are generally cheaper than the alternatives of roasted beans, ground coffee and K-cup coffee.

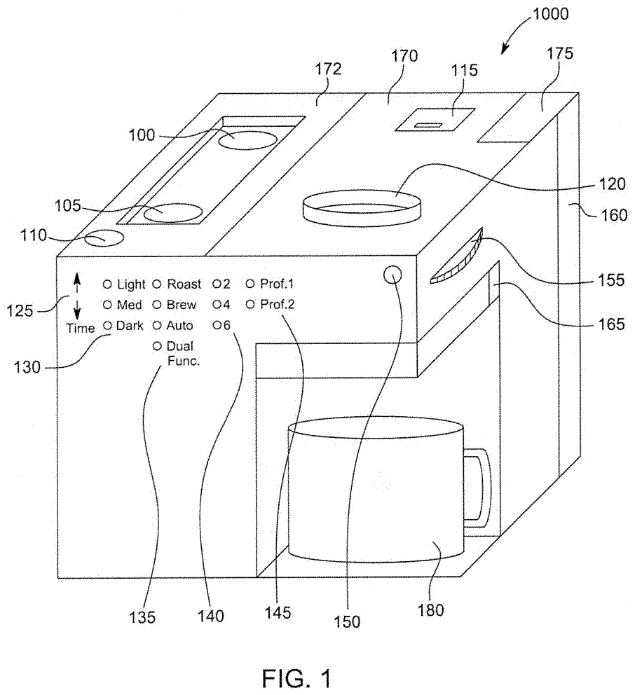

FIG. 1 is perspective view of an exterior of an example automatic coffee bean roaster, grinder and brewer device 1000. As seen in FIG. 1, the device 1000 may include an external housing 170, giving the device 1000 a pleasing aesthetic appearance. A hollow may be defined in the housing 170 for accepting a brewed coffee receptacle, such as a cup or a pot. A water tank 160 may likewise be detachedly coupled to the device 1000 to allow filling of water for brewing operations. In some embodiments a filling door 115 is provided for filling the water tank 160. A filling door 115 may be used to deposit roasted coffee beans directly in the grinder, bypassing the roasting operation provided by the device 1000.

A variety of input controls 125, 130, 135, 140 and 155 may be provided for allowing control of the brewing operation. The input controls may take the form of physical buttons, touch-based computer-controlled buttons, dials, or any other input device that may be deemed appropriate.

In certain embodiments, a time control 125 may be provided for controlling a time of the roasting operation and/or the degassing/oxidizing operation. A color control 130 may be provided for controlling a desired darkness of the roast. An automation control 135 may be provided for one-touch control of automatic roasting, automatic brewing, or full automatic roasting, grinding, degassing and brewing. A quantity control 140 may be provided for setting a quantity of coffee to be brewed, such as 2, 4 or 6 cups. Profile controls 145 may be provided which enable storage and retrieval of custom user brewing profiles, for immediate recall by single selection of a profile button. A power button 150 may be provided for enabling activation and deactivation of the device 1000. A dial 155 may be provided for controlling any of a variety of factors related to the roasting, grinding and degassing of the coffee, such as time, temperature, granularity, quantity, etc.

A drip tray 165 may be removably (or slidably) coupled to the housing 170, to enable access to and disposal of used coffee grounds from the side or from the front.

A tray 120 may be provided for storing raw coffee beans. When the user desires it, the user may access the tray 120 to cause the raw coffee beans to fall into the device 1000 for processing. This can be activated manually (e.g., by exposing an opening underneath the tray via some user-actuated mechanical action) or automatically (e.g., the device 1000 actuates a door causing the raw beans to fall into the machine through a bottom of the tray). In certain embodiments, a secondary opening 110 may be provided to allow for raw coffee beans to be deposited directly into the roasting chamber, bypassing storage in the tray 120.

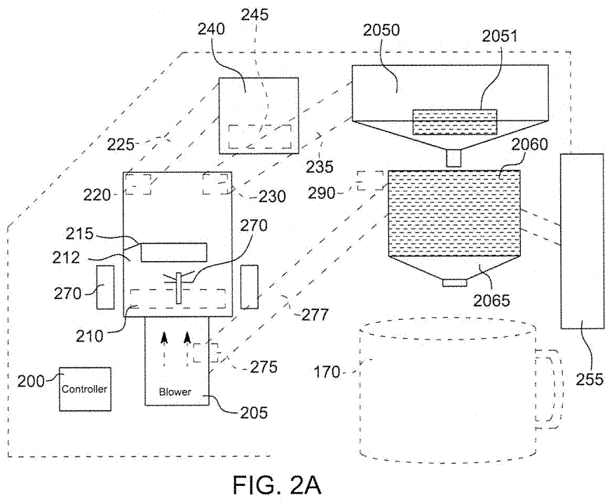

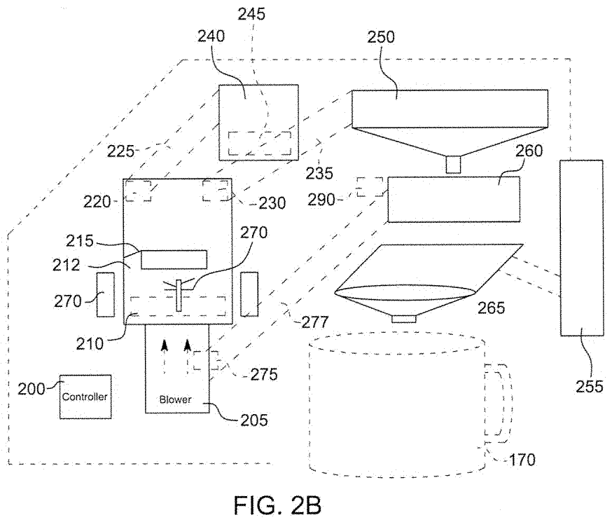

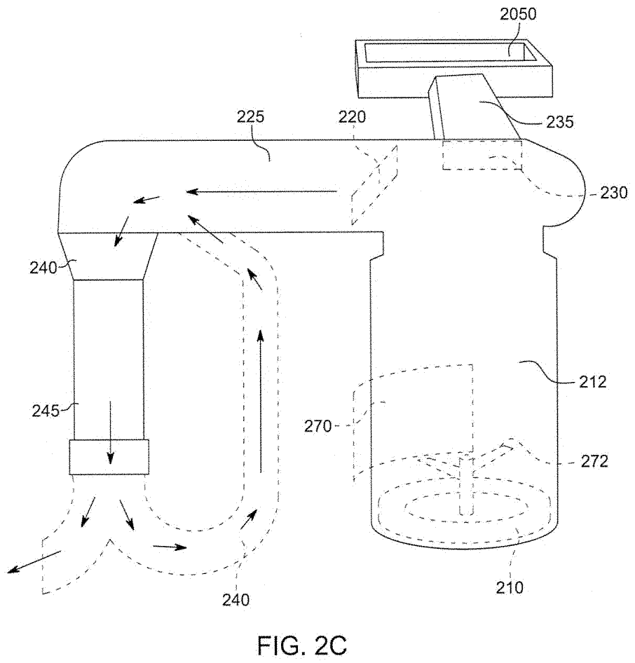

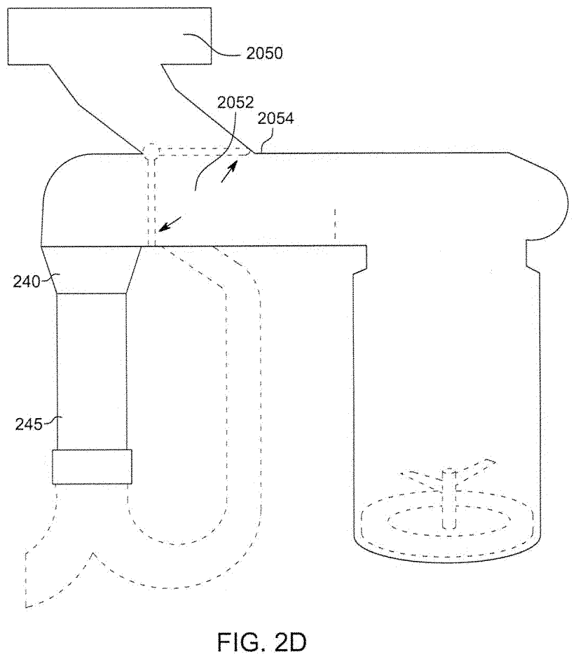

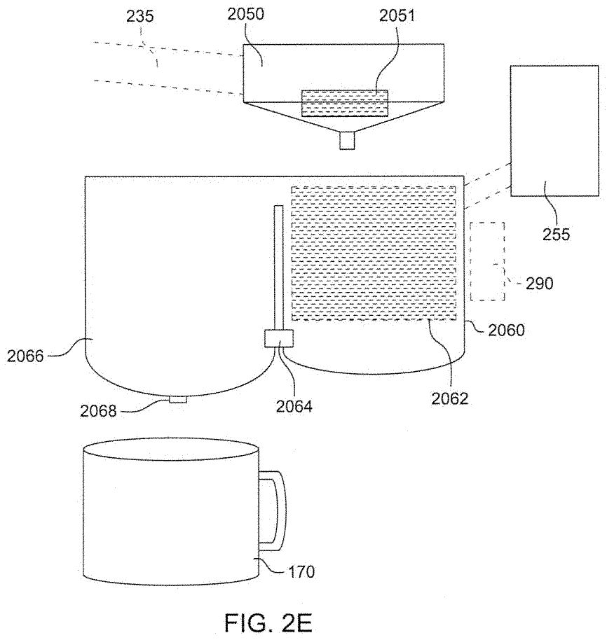

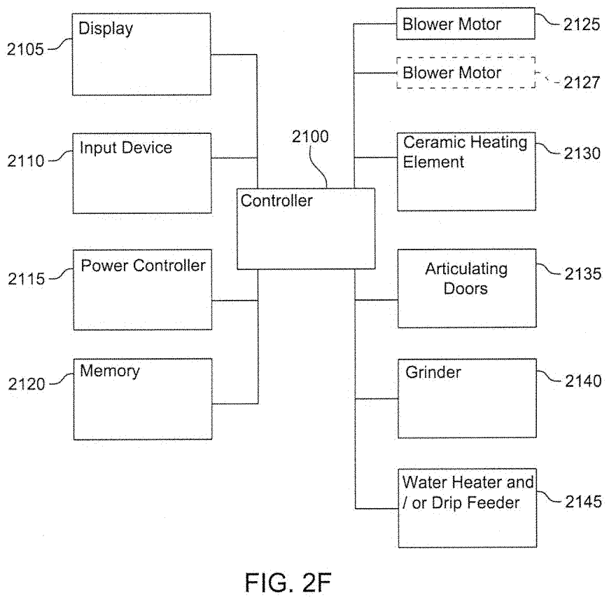

FIG. 2A is an interior view of components in a first example automatic coffee bean roaster, grinder and brewer.

When the raw coffee beans enter the device 1000 from the tray 120, they are shunted into the roasting chamber 212. The roasting chamber 212 may include a ceramic heating element 215 or 270. In certain embodiments, the ceramic heating element 215 is disposed within the chamber. In certain embodiments, the ceramic heating element 270 is disposed flanking the roasting chamber 212. Here, the roasting chamber 212 may be at least partially formed of heat-resistant glass, so that heat directed from the ceramic heating element 215 is directed inwards towards a center of the roasting chamber 212 through the heat-resistant glass.

The roasting chamber 212 may include a base 210. The base 210 may include openings defined within it, allowing airflow from a blower motor 205 to pass through into the roasting chamber 212. Consequently, the airflow from the blower motor 205 causes coffee beans within the roasting chamber 212 to churn, stir, and mix while being roasted by the ceramic heating element 215 or 270, resulting in a more even roast. In certain embodiments, a mixer 272 is attached to the base 210. The mixer 272 may be shape as to disturb the churn of coffee beans caused by the airflow, resulting in greater dispersion of the beans during churning and improving the evenness of the roast. The mixer 272 may be designed to facilitate this church by arms, protrusions, angled surfaces, etc., over which the beans must contact and flow as they church within the roasting chamber 212.

During the roasting process, a door 220 may be opened leading to a first venting shaft (or shunt) 225. Coffee skins will be released during the roasting process. As the coffee skins are very light, the airflow form the blower motor 205 will cause the skins to rise upwards and escape the roasting chamber 212 through the door 220. The skins then travel through the first venting shaft 225 to a coffee skin receptacle 240. The coffee skin receptacle 240 may include a mesh filter (not depicted) to catch the coffee skins as the airflow is vested through an exhaust (not depicted). Furthermore, between the mesh filter and the exhaust, a catalytic converter 245 may be disposed, forcing the airflow from the roast to interact with catalytic elements, reducing the harshness and/or degree of the smell of the roast within the airflow, prior to being vented through the exhaust. In some embodiments, the exhaust may be designed such that a first portion of the airflow vents to the exhaust, whereas a second portion is reintroduced as to pass through the catalytic converter 245 one or more times again, resulting in further reduction in harshness and smell (as seen in FIG. 2C).

Windows 100 and 105 (as seen in FIG. 1) may be formed in the housing 170 to allow for visibility into the roasting chamber 212 and the coffee skin receptacle 240. Furthermore, the coffee skin receptacle 240 may be detachably removed from the housing 170 to allow for disposal of accumulated coffee skins.

After the roasting process is complete, the device 1000 may deactivate the ceramic heating element 215 or 270, but maintain activation of the blower motor 205 to cool the roasted coffee beans. In some embodiments, the blower motor 205 may be operated at a same speed as during roasting to continue churning the beans. In other embodiments, the blower motor 205 may be operated at a slower or faster speed. After the cooling of the roasted beans is complete, the device 1000 may disable the blower motor 205, actuate closing of the door 220, and actuate opening of the door 230, connecting the roasting chamber 212 to a second venting shaft 235. The blower motor 205 may be re-activated to propel the roasted coffee beans into the second venting shaft 235, for deposit in the coffee grinder 250. The blower motor 205 may be operated for a time sufficient for expulsion of all the roasted coffee beans from the roasting chamber 212. The blower motor 205 may be operated at a same speed or at a different speed for expulsion of the roasted coffee beans as compared to the speed operated for the roasting operation.

After the roasted coffee beans are deposited in the grinder 2050, they may be ground into coffee grounds. The grinder 2050 may utilize a tooth-based grinding bit 2051 to grind the coffee beans into coffee grounds. The bit 2051 may have sufficiently small openings such that only coffee grounds can fall through the grinding bit 2051 by gravity into the degassing chamber 2060. Once the roasted coffee beans are fully grounded, the grinder 2050 may be deactivated. This may be controlled by a set time. Alternatively, more complex solutions may be utilized, such as a set time according to a quantity of coffee beans and/or a desired granularity of the coffee grounds.

In some embodiments, before the coffee beans are ground, they may be allowed to rest in the grinder 250, if desired by a user; e.g., for a span of 1 to 3 days. That is, natural degassing operations may be permitted according to when the user decides to initiate grinding.

After the coffee grounds are deposited into the degassing chamber 2060 (which in this embodiment, doubles as a brewing chamber), a door 275 may be actuated, connecting the blower motor 205 to the degassing chamber through a third vent shaft 277. The blower motor 205 may then be activated (either at a same speed as previously, or at a new speed) which introduces positive pressure airflow into the degassing chamber 260, resulting in rapid degassing and/or oxidization of the coffee grounds, which removes bitterness and unevenness from the flavor of any resulting brewed coffee. Alternatively, the door 275 may be open all the time so that when the beans are being roasted in the roasting chamber 212, the degassing chamber 260 may be dried with the aid of flow of air from the blower 205 via the third vent shaft 277.

In some embodiments, a different blower motor 290 is utilized for the degassing and oxidizing operation, in which case the door 275 and vent shaft 277 may be omitted. In a different mode, while the beans are roasted in the roasting chamber 212, previously roasted beans stored in the grinder 2050 can be brewed at the same time. That is the function of roasting can be independently and performed from the brewing operation, thus allowing the users to have an option of brewing previously roasted beans stored in the grinder 2050 at desired later time. During this operation, the smell of brewing coffee and a little amount of burnt smell from roasting will occur at the same time, thereby hiding the burnt smell and producing a more pleasant aroma.

In some embodiments the degassing chamber 260 is formed at least partially of mesh, to enable increased airflow in and through the chamber. In some embodiments, an exhaust may be connected to the degassing chamber 260 to allow ventilation of the airflow after degassing.

After the coffee grounds are sufficient degassed and/or oxidized, the blower motor 205 is deactivated. In some embodiments, the door 275 may be actuated to close.

Subsequently, heated water may be introduced from the water tank 255 into the degassing chamber 260, which interacts with the coffee grounds through the mesh. The resulting brewed coffee may drip through the drip feeder 2065, and be caught in the receptacle 180 for consumption.

FIG. 2B is an interior view of components in the second example automatic coffee bean roaster, grinder and brewer. This embodiment differs from that of FIG. 2A mainly in the usage of a separate degassing chamber 260 and brewing tray 265, whereas in FIG. 2A, a single chamber 2060 is used for both degassing and brewing functions.

When the raw coffee beans enter the machine from the tray 120, they are shunted into the roasting chamber 212. The roasting chamber 212 may include a ceramic heating element. In certain embodiments, the ceramic heating element 215 is disposed within the chamber. In certain embodiments, the ceramic heating element 270 is disposed flanking the roasting chamber 212. Here, the roasting chamber 212 may be at least partially formed of heat-resistant glass, so that heat directed from the ceramic heating element 215 is directed inwards towards a center of the roasting chamber 212 through the heat-resistant glass.

The roasting chamber 212 may include a base 210. The base 210 may include openings defined within it, allowing airflow from a blower motor 205 to pass through into the roasting chamber 212. Consequently, the airflow from the blower motor 205 causes coffee beans within the roasting chamber 212 to churn, stir, and mix while being roasted by the ceramic heating element 215 or 270, resulting in a more even roast. In certain embodiments, a mixer 272 is attached to the base 210. The mixer 272 may be shape as to disturb the churn of coffee beans caused by the airflow, resulting in greater dispersion of the beans during churning and improving the evenness of the roast. The mixer 272 may be designed to facilitate this church by arms, protrusions, angled surfaces, etc., over which the beans must contact and flow as they church within the roasting chamber 212.

During the roasting process, a door 220 may be opened leading to a first venting shaft (or shunt) 225. Coffee skins will be released during the roasting process. As the coffee skins are very light, the airflow form the blower motor 205 will cause the skins to rise upwards and escape the roasting chamber 212 through the door 220. The skins then travel through the first venting shaft 225 to a coffee skin receptacle 240. The coffee skin receptacle 240 may include a mesh filter (not depicted) to catch the coffee skins as the airflow is vested through an exhaust (not depicted). Furthermore, between the mesh filter and the exhaust, a catalytic converter 245 may be disposed, forcing the airflow from the roast to interact with catalytic elements, reducing the harshness and/or degree of the smell of the roast within the airflow, prior to being vented through the exhaust. In some embodiments, the exhaust may be designed such that a first portion of the airflow vents to the exhaust, whereas a second portion is reintroduced as to pass through the catalytic converter 245 one or more times again, resulting in further reduction in harshness and smell.

Windows 100 and 105 (as seen in FIG. 1) may be formed in the housing 170 to allow for visibility into the roasting chamber 212 and the coffee skin receptacle 240. Furthermore, the coffee skin receptacle 240 may be detachably removed from the housing 170 to allow for disposal of accumulated coffee skins.

After the roasting process is complete, the device 1000 may deactivate the ceramic heating element 215 or 270, but maintain activation of the blower motor 205 to cool the roasted coffee beans. In some embodiments, the blower motor 205 may be operated at a same speed as during roasting to continue churning the beans. In other embodiments, the blower motor 205 may be operated at a slower or faster speed. After the cooling of the roasted beans is complete, the device 1000 may disable the blower motor 205, actuate closing of the door 220, and actuate opening of the door 230, connecting the roasting chamber 212 to a second venting shaft 235. The blower motor 205 may be re-activated to propel the roasted coffee beans into the second venting shaft 235, for deposit in the coffee grinder 250. The blower motor 205 may be operated for a time sufficient for expulsion of all the roasted coffee beans from the roasting chamber 212. The blower motor 205 may be operated at a same speed or at a different speed for expulsion of the roasted coffee beans as compared to the speed operated for the roasting operation.

After the roasted coffee beans are deposited in the grinder 250, they may be ground into coffee grounds. After grinding is complete, the grinder 250 may actuate an opening allowing for depositing of the coffee grounds into a degassing chamber 260.

In some embodiments, before the coffee beans are ground, they may be allowed to rest in the grinder 250, if desired by a user; e.g., for a span of 1 to 3 days. That is, natural degassing operations may be permitted according to when the user decides to initiate grinding.

After the coffee grounds are deposited into the degassing chamber 260, a door 275 may be actuated, connecting the blower motor 205 to the degassing chamber through a third vent shaft 277. The blower motor 205 may then be activated (either at a same speed as previously, or at a new speed) which introduces positive pressure airflow into the degassing chamber 260, resulting in rapid degassing and/or oxidization of the coffee grounds, which removes bitterness and unevenness from the flavor of any resulting brewed coffee. In some embodiments the degassing chamber 260 is formed at least partially of mesh, to enable increased airflow in and through the chamber. In some embodiments, an exhaust may be connected to the degassing chamber 260 to allow ventilation of the airflow after degassing. In some embodiments, a different blower motor 290 is utilized to degas and oxidize the coffee grounds, separate from the blower motor 205.

After the coffee grounds are sufficient degassed and/or oxidized, the blower motor 205 is deactivated. In some embodiments, the door 275 may be actuated to close. The degassing chamber 260 may, in some embodiments, include an actuatable door through which the coffee grounds may be dropped into a drip tray 265. In some embodiments, a protrusion (e.g., an arm or other mechanical implement) may sweep within the degassing chamber 260 to cause a majority of the coffee grounds to drop through the door into the drip tray 265.

Subsequently, water may be provided from the water tank 255 (e.g., whether heated previously or heated en route) and then introduced to the coffee grounds in the drip tray 265. The resulting coffee brew may exit the drip tray from a nozzle into appropriate receptacle 180 (as in FIG. 1).

FIG. 2C is an sectional view of a roaster chamber, skin receptacle and catalytic converter, as utilized within the example automatic coffee bean roaster, grinder and brewer. FIG. 2C is provided to show more detail of the embodiment as compared to the previous description in FIG. 2A.

The roasting chamber 212 is illustrated herein as generally cylindrical, although any shape as desired may be utilized. The base 210 is provided, illustrated here with a number of angled openings to allow airflow into the roasting chamber. The angle of the openings causes the airflow to spiral, resulting in a circular churning of coffee beans deposited in the roasting chamber 212. A mixing protrusion 272 is provided to enable more even mixing of the beans during churning. FIG. 2C further illustrates the example of an external ceramic heating element 270, which directs heat into the roasting chamber 212 through a transparent portion of the roasting chamber 212 (e.g., formed of heat-resistant glass).

Two doors 230 and 220 are provided for access to vent shafts 225 and 235, connecting to the skin receptacle 240 and grinder 2050, respectively. During the roasting operation, door 220 is open, for which coffee skins, propelled by the air flow, travel out the door 200, through the vent shaft 225, and are caught by the coffee skin receptacle 240. The receptacle 240 may be removable from the device 1000 for easy cleaning and disposal of coffee skins. The receptacle 240 may have openings defined therein to allow airflow to pass through, for exhaust, without accidentally discharging coffee skins from the device 1000.

A catalytic converter 245 is provided for reducing fumes and harshness generated by roasting, which would necessarily be included in the airflow from the roasting chamber 212. As seen here, in some embodiments, the exhaust 247 may contain multiple passages so that some of the catalyzed airflow is rerouted into the vent shaft 225 to again pass through the catalytic converter 245 and further reduce the harshness and fumes resultant from the roasting operation.

FIG. 2D is an sectional view of a roaster chamber, skin receptacle and catalytic converter, as utilized within another example automatic coffee bean roaster, grinder and brewer. The embodiment of FIG. 2D differs from that of FIG. 2C in that a single vent shunt 2054 is provided for connecting the roasting chamber to the grinder 2050 and the coffee skin receptacle 240. As seen in FIG. 2D, the single channel splits at a Y-junction, one junction leading to the coffee skin receptacle 240 and the other to the grinder 2050. An actuated door 2052 is provided for blocking off each wing of the junction during different phases of operation. For example, when skins are being directed to the coffee skin receptacle 240, the door 2052 may be actuated such that access to the grinder 2050 is blocked. Likewise, when roasted beans are being directed to the grinder 2050, the door 2052 may be actuated such that access to the coffee skin receptacle is blocked.

FIG. 2E is a sectional view of a grinder, water tank, and combination degassing-oxidizing brewing chamber. FIG. 2E is provided to show more detail of the embodiment as compared to the previous description in FIG. 2A.

Roasted coffee beans are deposited in the grinder 2050 from travel through the vent shunt 235. The grinder 2050 may grind the roasted coffee beans into coffee grounds. As noted earlier, the grinder 2050 may utilize a grinding teeth and/or gearing 2051 to grind the roast beans into coffee grounds. The grinding teeth 2051 may have openings defined between the teeth such that only coffee grounds will fall through to the degassing and brewing chamber 2060.

As described earlier, the degassing and brewing chamber 2060 may include within it a mesh container 2062. The blower motor 290 may push airflow through the mesh to oxidize and/or degas the coffee beans. The blower motor 290 may operate for a set quantity of time or for a time custom set by a user. Once the set time is elapsed, heated water may be introduced to the ground coffee in the mesh from the water tank 255 to brew coffee.

The brewed coffee flows out of the mesh container 2062, through a channel 2064 into an overflow tank 2066, which slowly drips the brewed coffee through the nozzle 2068 into the receptacle 180.

In another embodiment, the blower motor 290 may reverse airflow as to create a vacuum within the degassing and brewing chamber 2060. In this embodiment, the creation of a vacuum within the degassing and brewing chamber 2060 may aid with degassing by pulling carbon dioxide and other gasses creating during roasting from the coffee beans. The degassing and brewing chamber 2060 may further be formed as to be airtight. In this embodiment, openings such as the nozzle 2068 and/or the channel 2064 may be selectively closed to create a sealed environment for the vacuum. Subsequently, after vacuum-based degassing is complete, the degassed coffee beans may be brewed in the same manner as with the previous embodiment.

FIG. 2F illustrates internal components of the example automatic coffee bean roaster via control of a computer controller.

The device 1000 may include computer components including a central processing unit or controller 2100, a display 2105, an input device 2110, a power controller 2115 and a memory 2120. The controller 2100 may include a central processing unit (either single or multi-core), which may read software instructions and execute the corresponding operations, such as to implement control of the various components of the device, like the blower motor 2125, blower motor 2127, ceramic heater(s) 2130, articulating doors 2135, the grinder 2140, and the water drip feeder and/or water heater 2145.

A display 2105 may be provided, as disposed on an external housing of the device 1000, in order to provide visual feedback for current operations, status, inputs, etc. of the device 1000 to the user. The display 2105 may be implemented using any available display technology, such as the use of high resolution LED and/or OLED touch displays. The display 2105 may also utilize simpler solutions such as LCD displays, which require less cost and are beneficial for smaller screens displaying less variety of information.

An input device 2110 may be provided, which may include input circuitry for implement a variety of user-interactable controls, such as the controls 125, 130, 135, 140, 145, 150 and 155 indicated in FIG. 1. The controls may take the form of physically depressible buttons, touch-enabled controls, dials, slides, and any other implement beneficial for allowing the user to control the settings of the device 1000.

A power controller 2115 may be provided for regulating the inflow of power from a power source (e.g., a wall outlet) to the device 1000. The power controller 2115 may regulate power to the computerized components, such as the controller 2000 and memory 2020. The power controller 2115 may further regulate—as controlled by the controller 2000—power flow to the various mechanically actuated components of the device 1000, such as the blower motor 2125, blower motor 2127, ceramic heater 2130, articulating doors 2135, grinder 2140 and water heater and/or drip feeder 2145.

The memory 2120 may be operably connected to the controller 2100, and store instructions which are executable by the controller 2100 to actuate the various functions of the device 1000, as will be described later below. The memory 2120 may also store settings and configurations programmed by the user for the roasting, grinding and brewing of coffee. For example, if a user designates a dark roast, a fine ground, a twenty minute degassing and/or oxidation, and a particular temperature of water for brewing, the memory 2120 may be used to store those settings as a particular brewing profile for the user, for later recall.

The controller 2000 may further control, according to the programming instructions, the operation of components needed to road, grind and oxidize/degas the coffee, as seen below.

A blower motor 2125 may be provided to generate airflow for the roasting process (e.g., to churn the beans during roasting and expel skins out of the roasting chamber), to force roasted beans out of the roasting chamber and to the grinder, and lastly, the provider positive pressure airflow for oxidizing and/or degassing the coffee grounds.

In some embodiments, a separate blower motor 2127 is provided specifically for the degassing and oxidizing operations, separate from the blower motor 2125. In this embodiment the blower motor 2125 would not be used for degassing and oxidizing operations, and any linkages, vents and doors for this purpose would be omitted.

A ceramic heating element 2130 may be provided to generate directed heat for roasting the raw coffee beans. As noted earlier, the ceramic heating element 2030 may be disposed within the roasting chamber (e.g., suspended centrally by a support member extending from an interior wall thereof). Alternatively, the ceramic heating element 2130 may be disposed outside the roasting chamber, and directed heat into the roasting chamber through heat-resistant glass forming at least a portion of the roasting chamber. This may be beneficial for preventing coffee skins from “sticking” to the ceramic heating element and burning on it.

Articulating doors 2135 may be provided for opening and closing access to the various vents, shunts and other connections between the processing chambers of the device 1000. For example, the skin receptacle and grinder chamber are connected to the roasting chamber via two venting shunts. Likewise, the blower motor is connected to the oxidizing-degassing chamber via another venting shunt.

The grinder 2140 may be provided for grinding roast coffee beans into coffee grounds in preparation for oxidizing-degassing and brewing.

Lastly, a water heater and/or water drip feeder 2145 may be provided for heating water (e.g., to boiling) and introducing water to coffee grounds in the drip feeder to brew coffee.

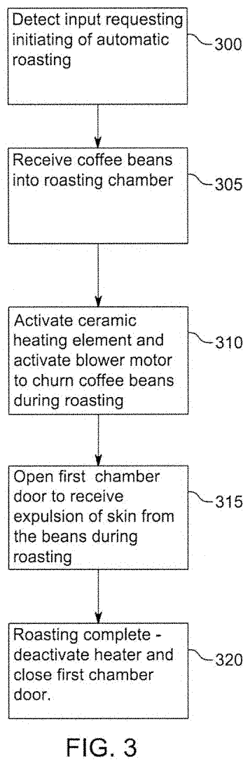

FIG. 3 is a flowchart illustrating an example method of roasting coffee beans in the example automatic coffee bean roaster, grinder and brewer.

In certain embodiments, in operation 300, the device 1000 may receive an input requesting initiation of roasting coffee beans for brewing. Subsequently, the device 1000 (through the controller 2000 and memory 2020) may receive raw coffee beans into the roasting chamber, as seen in operation 305. Subsequently in operation 310, the ceramic heating element may be activated, initiating roasting of the raw beans. Furthermore, the blower motor may be activated. As described previously, a base of the roasting chamber may including openings which direct airflow into the roasting chamber. The openings may be cut at angles, so that the beans churn in a rotating pattern in response to the airflow. Accordingly, the raw coffee beans may be roasted more evenly.

In operation 315, a first chamber door may be opened, connecting the roasting chamber to the coffee skin receptacle. As airflow is introduced to the roasting chamber, and as skins fall off the coffee beans as a consequence of roasting, the skins may be blown upwards by the airflow, through the first chamber door, and eventually into the coffee skin receptacle where they are collected. The coffee skin receptacle may include a mesh for catching the coffee skins before they exhaust to an exterior. As noted earlier, a catalytic converted may likewise be provided reducing harshness and smell of the airflow as it exhausts to the exterior.

After a designated period of time, the roasting operation may be deemed complete in operation 320. Accordingly, the activated components of the ceramic heating element may be deactivated. The first chamber door for expelling coffee skins may be closed. The blower motor may be maintained so as to cool the beans in preparation for grinding.

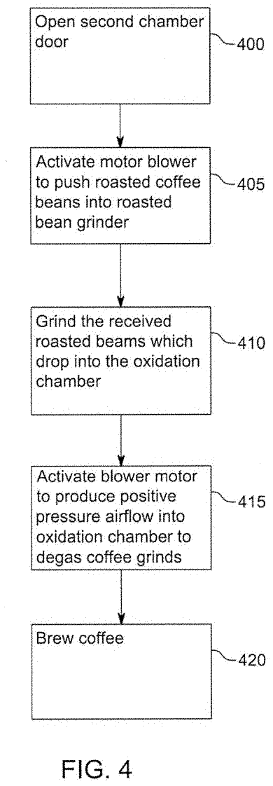

FIG. 4 is a flowchart illustrating an example method of grinding the roasted coffee beans and exposing the grounds to oxidation in the example automatic coffee bean roaster, grinder and brewer.

After the roasting process and cooling are complete, as described in FIG. 3, then in operation 400, a second chamber door in the roaster chamber may be opened (e.g., by actuation by control of the controller), which connects the roaster chamber to the grinder via another venting shunt.

In operation 405, the blower motor is reactivated to generate airflow propelling the roasted coffee beans out of the roasting chamber through the second chamber door, into the grinder. In some embodiments, the blower motor here may be activated at a higher speed compared to the airflow generated during the roasting process. The rationale is that during roasting, it is desirable for the coffee beans to churn. However, now, the coffee beans are being propelled out of the roasting chamber. Once the roasted coffee beans have been fully expelled from the roasting chamber, the blower motor may be deactivated. This may be determined by a sensor, or, alternatively, set times of activation may be stored and utilized for known quantities of beans.

In operation 410, the grinder may be activated (e.g., by control of the controller) to grind the received roasted coffee beans into coffee grounds. In some embodiments, the roasted coffee beans may be allowed to sit in the grinder and naturally degas. At other times (e.g., when the user desires automated roasting, grinding and brewing, with no delay), the grinding operation may proceed immediately from the roasting operation with minimal delay. Once grinding is complete, the grinder may be deactivated by control of the controller. The time of grinding may be set using a preset time according to a known quantity of coffee. Alternatively, the preset time may factor the quantity of coffee and a desired granularity of the coffee (e.g., for a certain quantity, a finer granularity requires longer grinding). Alternatively, a sensor may be provide to detect a granularity of the grounds, and the grinder may be deactivated once a desired granularity is achieved.

In operation 415, after grinding, the coffee grounds may drop into the degasser and brewing chamber. Positive airflow may be generated by a blower motor, which oxidizes and degasses the coffee grounds. Once the degassing operation is complete, the blower motor may be deactivated.

In operation 420, hot water may be introduced to the coffee grounds, resulting in brewed coffee, which may then be drip-fed to a receptacle, as described earlier in the application.

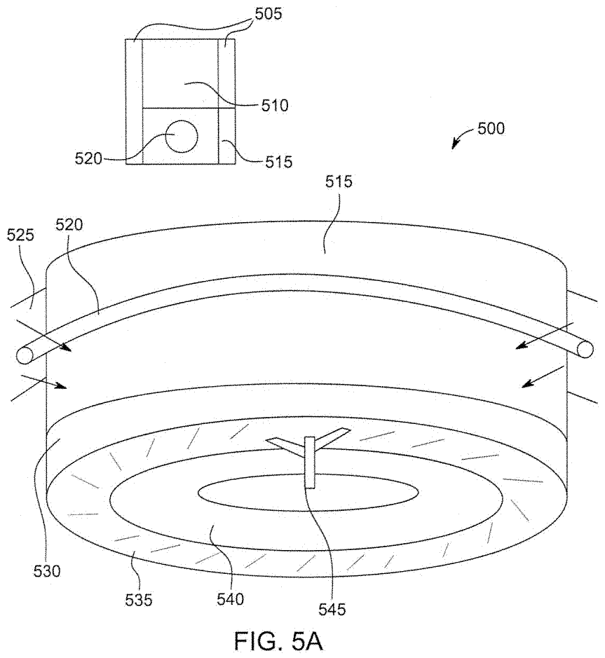

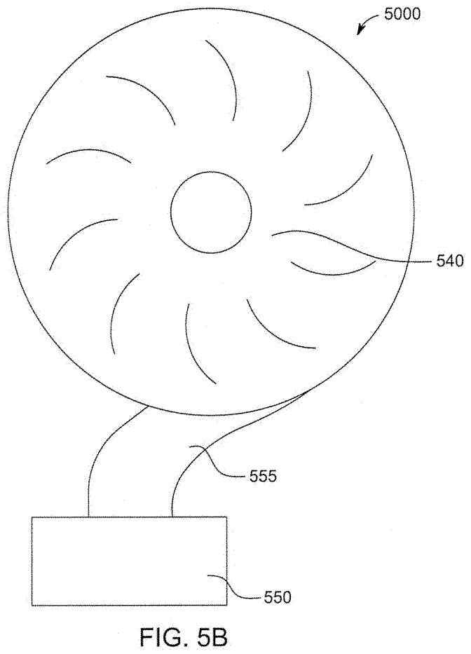

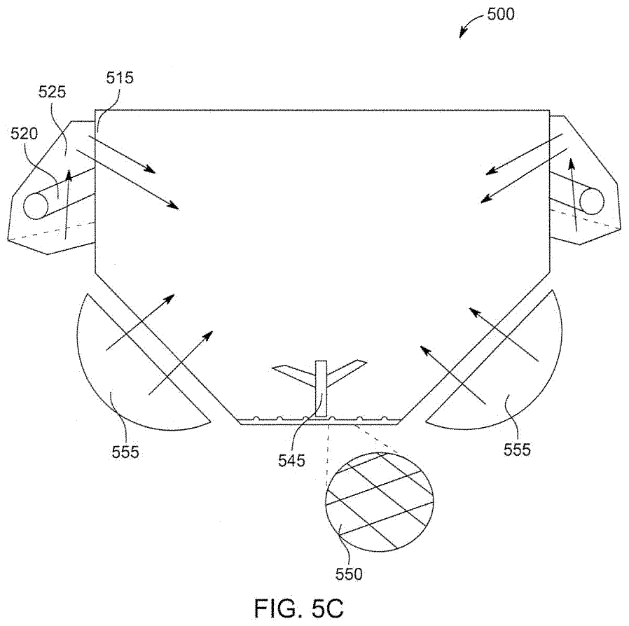

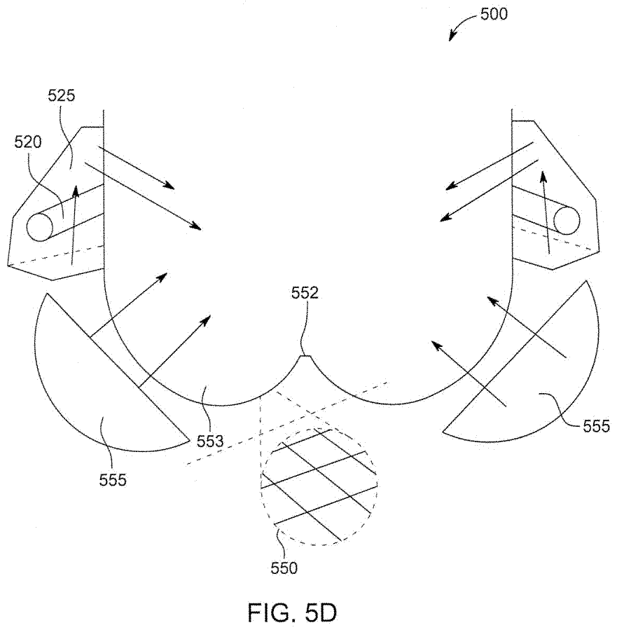

FIG. 5A illustrates an example roasting chamber according to certain embodiments of the invention. A cross section of a wall of the example roasting chamber 500 is shown, in which the wall includes metal layers 505, which surround a central ceramic material 510. Below this, the ceramic heating element 520 is disposed in an enclosed hollow and surrounded by two plates 550 and 560 at an angle to deflect the heated generated by the ceramic heating element 520 toward the center of the roasting chamber 500, and a glass material 515 is used to allow heat generated by the ceramic heating element 520 and reflected by the two plates 550 and 560 to be radiated towards the center of the roast chamber 500, to roast raw coffee beans. The two plates 550 and 560 can be made of metal plates or other materials capable of deflecting the heat generated by the ceramic heating element 520. The structure of the wall in which ceramics and metals are layered to produce structural elements of the housing of the roast chamber 500 may provide beneficial insulation qualities to the housing and prevent the housing from becoming excessively hot to the touch.

In alternate embodiment, the heating element 520 is equipped with a radiating shield 525 which redirects generated heat towards an interior of the roasting chamber 500 through the glass pane 515. Furthermore, a structural wall 530 may be provided joining the glass pane 515 to the base of the roasting chamber 500. The structural wall 530 may be formed of some suitable material different than the glass pane 515. The base may include a perforated plate having radiating grooves cut into a surface thereof 535, to cause inflow of air from the blower to spiral, thereby mixing the roasting beans. The base may also include a central mesh region 540, and a stationary mixing arm 545, as described in earlier embodiments.

FIG. 5B illustrates an example degassing chamber according to certain embodiments of the invention. More specifically, FIG. 5B shows an air blowing element that is disposed on the top of degassing chamber. As seen therein, a blower motor 550 may be connected by a channel 555 to the degassing chamber 5000. In this variation of the degassing chamber 500, the channel 555 may be oriented as to encourage formation of a vortex of air that blows the ground coffee in a spiral pattern during the degassing operation. The movement of the ground coffee in a spiral may aid in faster degassing due to greater exposure to air. The plate 540 may have grooves cut into its surface which likewise encourage the formation of the desired vortex of air for moving the ground coffee in a spiral. The plate 540 may have an opening at its center to allow the grounded beans to fall into the degassing chamber.

Further, while the ground coffee undergoes the air blowing process as described above, a steam can be applied to increase oxidation according to another embodiment. All chemical reactions have higher reaction at higher temperatures. Thus, a combination use of steam and the use of vacuum would remove the volatile components in coffee, thus the ground coffee degassed at an enhanced rate.

FIG. 5C illustrates a side view of another example roasting chamber according to certain embodiments of the invention. In this example of the roasting chamber 500, the base of the roasting chamber 500 is not flat. Instead, A flat base portion is flanked by sides rising diagonally to meet the glass walls 515 of the roasting chamber, which are (as before) transparent as to allow heat generated from the ceramic heating element 520 and directed from the shielding 525 to enter into the roasting chamber 500. As seen in 550, the bottom surface of the base may be covered in a “waffle” pattern of raised ridges. The waffle pattern may aid in the stirring and turnover of coffee beans as they circulate in the roasting chamber 500, propelled by airflow generated from the blower motor and entering into the roasting chamber 500 through the ducts 555.

FIG. 5D illustrates a side view of another example roasting chamber according to certain embodiments of the invention. The roasting chamber of FIG. 5D is similar to the example of FIG. 5C, except in this case, the base of the roasting chamber 500 is defined primarily by a single channel 553 circumferentially defined around a risen center 552. The channel 553 may define the channel through which the coffee beans will flow during the roasting process, as propelled by airflow entering into the roasting chamber 500 via the vents 555. As with the example above, the channel 553 may include on some or all of its inner surface a waffle pattern as seen in window 550, which may aid in the stirring and turnover of coffee beans as they circulate in the roasting chamber 500, propelled by airflow generated from the blower motor and entering into the roasting chamber 500 through the ducts 555.

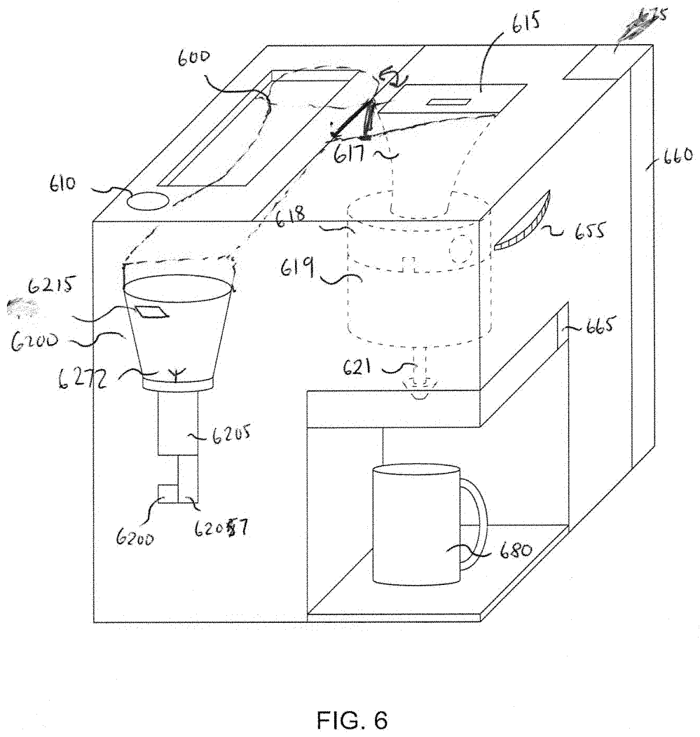

FIG. 6 is a perspective view of an exterior of another example automatic coffee bean roaster, grinder and brewer. As seen therein, FIG. 6 includes many components corresponding to the embodiment of FIG. 1, including for example, the water tank 660, input control 655 (i.e., a rotary dial), filling door 615, secondary opening 610, drip trap 665, etc., and as such, their descriptions will not be repeated herein.

FIG. 6 further illustrates internal components of the automatic coffee bean roaster, grinder and brewer. Referring to the left-side of FIG. 6, a roasting chamber 6200 is illustrated. A window 600 is provided (in singular form, contrary to the embodiment of FIG. 1), which may allow viewing of the interior of the roasting chamber 6200 during a roasting operation. Within the roasting chamber 6200, a heating element, such as n infrared LED 6215 (including either high or low frequency) may be provided for heating coffee beans deposited therein. A mixer 6272 may be provided for stirring the coffee beans as they are heated, so that the heat may be distributed over a surface area of more of the coffee beans. A blower 6205 is provided for cooling the coffee beans, aiding in mixing of the coffee beans by the mixer 6272, cooling and/or degassing roasted coffee beans, and/or forcing the coffee beans and skins in and out of the roaster chamber 6200. The blower 6205 may be controlled by a controller 6200, which may include some simple processor and/or circuit or the like.

A second internal component illustrated in FIG. 6 is the drip feeder 619. As noted elsewhere, the drip feeder 619 may receive roasted coffee beans through internal channels of the automatic coffee bean roaster, grind and brewer, or alternatively, through the filling door 615, which may open to allow deposition directly through the channel 617. The drip feeder 619 may include an integrated grinder 618, which may grind the roasted coffee beans into coffee grinds. Subsequently, heated water may be introduced into the coffee grounds within the drip feeder 619, resulting in brewed coffee dripping via the nozzle 621 into the receptable 680.

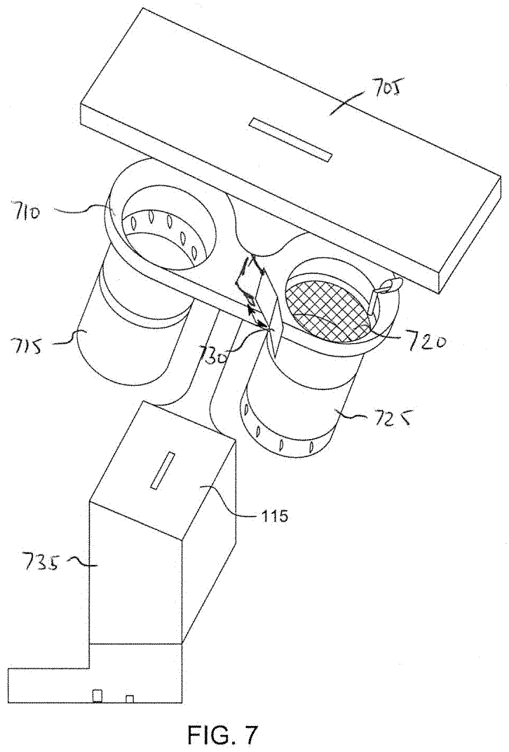

FIG. 7 is a perspective view of an example roasting chamber, skin (e.g., chaff) filter, and grinder. As seen therein, a plastic cover 705 may be provided for allowing user access to the roasting chamber 710 and the chaff filter 720. The roasting chamber 710 may include a hollow in which the coffee beans may be deposited for roasting, and utilize, for example a ceramic or LED heating element to accomplish the same. A fan blower 715 may be provided for aiding in mixing of the coffee beans, cooling the coffee beans, expelling skins from roasted coffee beans, and/or expelling the roasted coffee beans from the roasting chamber 710.

A hinged door 730 is provided for controlling whether contents expelled from the roasting chamber 710 enter into the chaff filter 720 or to the grinding device 735. That is, the hinged door 730 may be controlled by a processor to selective close either a channel leading to the chaff filter 720, or a channel leading to the grinding device 735.

The hinged door 730 may be controlled to direct contents to the chaff filter 720 when, for example, the coffee beans have been freshly roasted and the fan blower 715 is activated so as to blow skins (i.e., chaff) off the roasted coffee beans. The skins may then be caught by the chaff filter 720, and any lingering smells caused by roasting may be processed through the catalytic converted 725 before expulsion to an outside environment.

After the coffee grounds are deskinned, the hinged door 730 may be controlled to direct contents to the grinding device 735. The fan blower 715 may be operated at a particular speed as to generate sufficient airflow to expel the roasted, deskinned coffee beans out of the roasting chamber 710 and into the grinding device 735, for processing into coffee grounds. The grinding operation may be observed through the glass window 115.

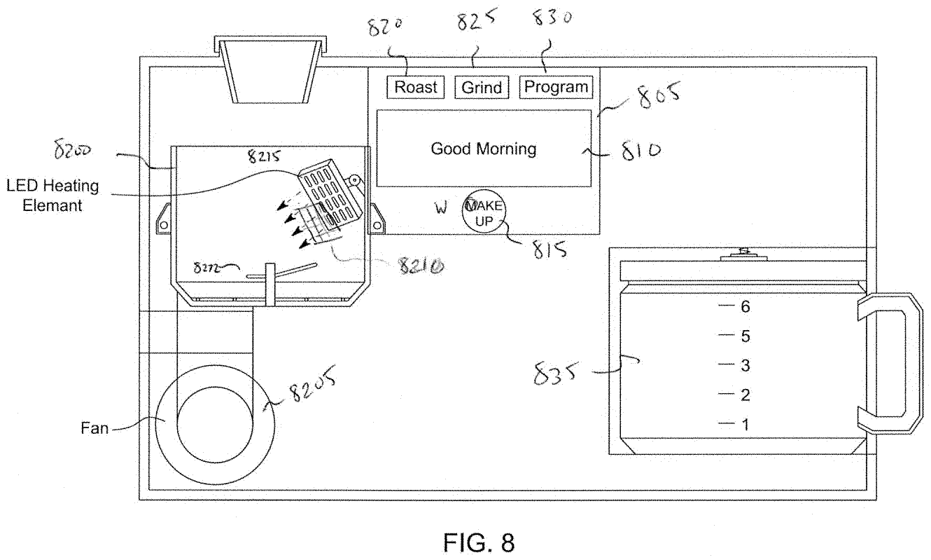

FIG. 8 is a perspective view of a front face of the automatic coffee roaster, grinder and degasser, with a cutaway showing internal components including the fan blower 8205 and roasting chamber 8200.

As seen in FIG. 8, another view is provided of the roasting chamber 8200, including a heating element (e.g., ceramic, LED or other) 8215, mixer 8272, and fan blower 8205. In some embodiments, a mesh screen 8210 may be provided to prevent coffee beans or skins from contacting directly with the heating element 8215, which may burn on contact.

A user interface panel 805 may be provided including selectable buttons 820, 825, and 830, along with a display 810 and a “wake up” button 815. The wake up button 815 may wake the automatic coffee roaster, grinder and degasser from a sleep state and/or low power state at times in which it is idle and not in operation. Subsequently, the user may select one of the basic operations using one of the buttons 820, 825 and 830, which corresponding to a roasting operation, a grinding operation, and a “program” operation (meaning some macro combination of existing commands). The display 810 may display additional details and/or options corresponding to the selected function. The display 810 may include a touch-sensitive display, allowing inputs to be made by touch and/or hover-based inputs to the display 810 surface.

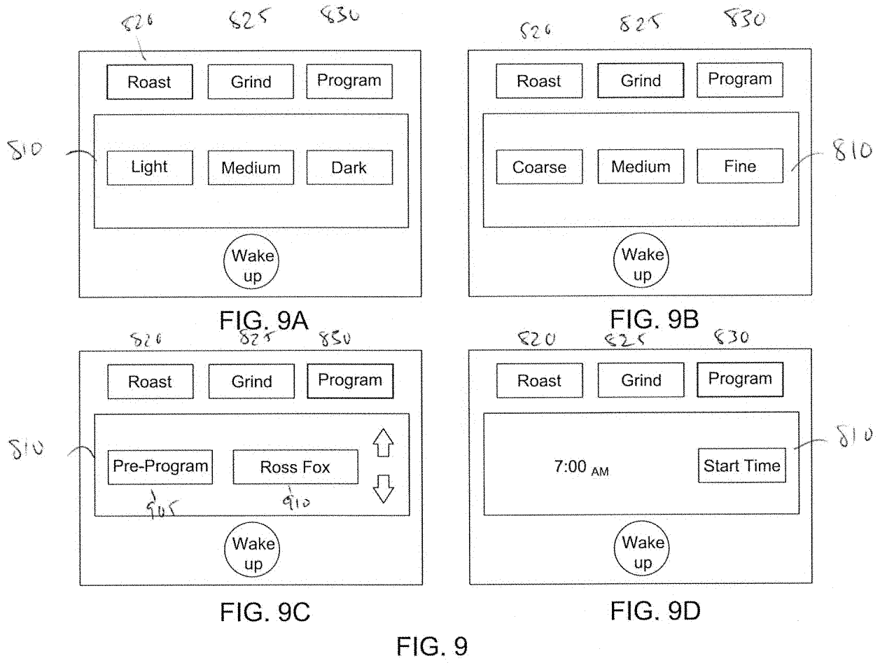

FIGS. 9A, 9B, 9C and 9D illustrate some example user interface elements for a control panel of the automatic coffee roaster, grinder and degasser.

As seen in FIG. 9A, a “roast” option 820 has been selected, upon which the display 810 may display selectable options of light, medium and dark roast, for controlling roasting of the coffee beans, which may be selected via touch input to the display 810.

As seen in FIG. 9B, a “grind” option 825 has been selected, upon which the display 810 may display selectable options of coarse, medium and fine, referring to the desired granularity of the resulting coffee grinds. As above, these options may be selected via touch input to the display 810.

As seen in FIG. 9C, a “program” option 830 has been selected, upon which the display may display selectable options “pre-program” 905 and “ross fox” 910. Selecting pre-program 905 may facilitate a user to generate a customized sequence of coffee brewing operations including for example a specific roast, a specific grind granularity, along with any other options that might be beneficial to this process (e.g., roasting time, temperature, roasting process or program of varying times and/or temperatures, grinding time, water temperature, etc.). Once a program has been created, it may be stored and associated with a custom name (e.g., which may be entered using the touch-sensitive display 810, the operation of which is not illustrated herein). Ross fox 910 may illustrate one such pre-created program. Once a program is created, selecting the name of the program (e.g., ross fox) will cause the corresponding brewing program to be executed.

As seen in FIG. 9D, after a program is selected, an automatic brewing time may also be designated. To this end, a present time may be displayed (e.g., 7:00 AM), along with a “start time” button 810 that is selectable to enter a start time. For instance, after the user has selected ross fox 910, the user may select the start time button 810, and then, through subsequent user interface elements, designate that brewing should begin at 7:30 AM. Then, when the automatic coffee roaster, grinder and degasser detects that a current time corresponds to 7:30 AM, brewing using the ross fox program may be automatically initiated.

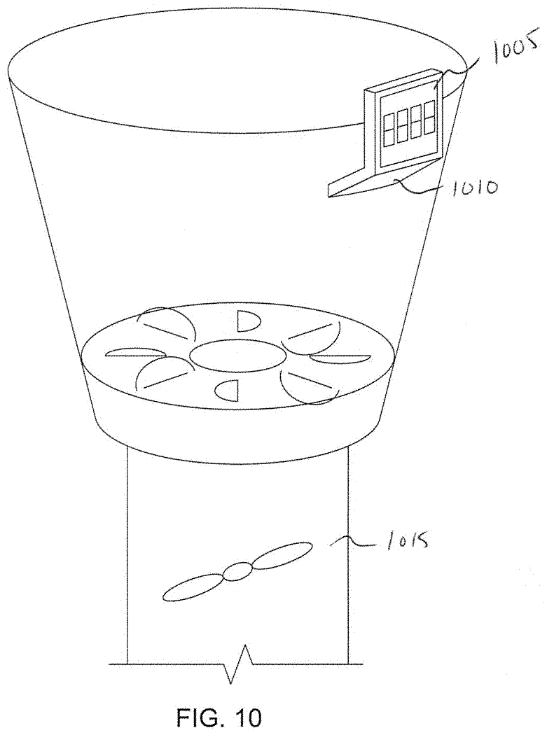

FIG. 10 is a perspective view of a roasting chamber. As seen therein, a heating element 1005 is provided, which may provide ceramic or LED-based heating. A mesh or shield 1010 may be provided so as to prevent stray coffee beans or skins from contacting the heating element 1005, which may otherwise burn on contact. The fan blower 1015 is disposed below the roasting chamber. As noted earlier, the fan blower 1015 may be variably operable so as to cool roasted beans, aid in mixing the coffee beans, cool and/or degas roasted coffee beans, and expel skins and/or coffee beans from the roasting chamber.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium (e.g., internal memory or external memory) that is readable by a machine (e.g., the device 1000). For example, a processor (e.g., the controller 2100) of the machine (e.g., the electronic device 1000) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A coffee roaster and degasser, comprising:
a roaster configured to roast raw coffee beans, thereby resulting in roasted coffee beans;
a grinder configured to grind the roasted coffee beans, thereby resulting in ground coffee; and
a degassing stage configured to accelerate degassing of carbon dioxide from the ground coffee.

2. The coffee roaster and degasser of claim 1, further comprising a blower motor configured to blow air at a first speed to stir the raw coffee beans inside the roaster during roasting.

3. The coffee roaster and degasser of claim 2, wherein the blower motor is further configured to blow air at a second speed to cause the raw coffee beans to be tossed from the roaster to the grinder.

4. The coffee roaster and degasser of claim 1, further comprises a filter for catching peals of the raw coffee beans.

5. The coffee roaster and degasser of claim 1, wherein the roaster comprises:
a heating element configured to generated heat;

6. The coffee roaster and degasser of claim 5, wherein the heating element is an infrared heater.

7. The coffee roaster and degasser of claim 5, further comprising:
an exhaust connected to the roaster to divert air heated by the heating element; and
a catalytic converter disposed near the exhaust.

8. The coffee roaster and degasser of claim 2, wherein the degassing stage comprises applying a degree of positive pressure over the ground coffee to accelerate the degassing of the ground coffee.

9. The coffee roaster and degasser of claim 8, wherein the blower motor configured to generate a flow of air such that ground coffee disposed within the degassing stage is centrifugally spun in sequence with application of the positive-pressure to accelerate the degassing of the ground coffee.

10. The coffee roaster and degasser of claim 1, further comprising a temperature sensor configured to monitor temperature within the roaster during the roasting of the raw coffee beans.

11. A method for preparing coffee in an electronic device, comprising:
roasting, by a roaster, raw coffee beans, thereby resulting in roasted coffee beans;
grinding the roasted coffee beans, thereby resulting in ground coffee; and
degassing carbon dioxide from the ground coffee.

12. The method of claim 11, wherein the degassing the carbon dioxide from the ground coffee comprises disposing the coffee grounds into a chamber, and applying positive-pressure air inside the chamber.

13. The method of claim 11, further comprising cooling the roasted coffee beans at a location where the coffee beans are roasted.

14. The method of claim 11, wherein the roasting the raw coffee beans comprises:
applying heat to the raw coffee beans by a heating element and blowing air generated by a fan thereby causing the raw coffee beans to be stirred; and
filtering peals of the raw coffee beans generated during the roasting of the coffee beans.

15. The method of claim 14, further comprising:
diverting the air heated by the heating element; and
filtering the air heated by the heating element with a catalytic converter.

16. The method of claim 14, further comprising cooling the roasted coffee beans by turning the heating element off and blowing air at a first speed by the fan.

17. The method of claim 14, further comprising blowing air at a second speed by the fan and causing the roasted coffee beans to be tossed from the roaster to the roasting to the grinding operations.

18. The method of claim 15, further comprising monitoring temperature of the roasted beans during roasting to adjust the heating element.

19. The method of claim 11, wherein degassing the ground coffee includes disposing the ground coffee in a chamber and applying positive-pressure to the coffee grounds.

20. A coffee roaster and degasser, comprising:
a roasting chamber configured to roast raw coffee beans, thereby resulting in roasted coffee beans;
a grinder configured to grind the roasted coffee beans, thereby resulting in ground coffee;
an oxidizing chamber configured to accelerate degassing of carbon dioxide from the ground coffee; and
at least one processor controlling the roasting chamber, the grinder and the oxidizing chamber.

21. The coffee roaster and degasser of claim 20, further comprising:
a coffee skin receptacle; and
a first channel connecting the roasting chamber to the coffee skin receptacle,
wherein the blower motor is operable to propel coffee skins released from the raw coffee beans during roasting from the roasting chamber, through the first channel into the coffee skin receptacle.

22. The coffee roaster and degasser of claim 21, further comprising:
a second channel connecting the roasting chamber to the grinder,
wherein the blower motor is operable to propel roasted coffee beans from the roasting chamber, through the second channel, into the grinder.

23. The coffee roaster and degasser of claim 22, further comprising:
a singular venting channel extending from the roasting chamber, splitting into the first channel and the second channel; and
a mechanical door, controlled by the at least one processor, actuatable to selectively close the first channel and open the second channel, and selectively close the second channel and open the first channel.
